(19) United States
(12) Patent Application Publication
(10) Pub. No.: US 2017/0200208 A1
(43) Pub. Date: Jul. 13, 2017

(54) SALES SUPPORT METHOD AND SALES SUPPORT SYSTEM

(71) Applicant: Panasonic Intellectual Property Management Co., Ltd., Osaka (JP)

(72) Inventors: Sako KONDO, Osaka (JP); Takeshi WAKAKO, Kanagawa (JP); Yoshinori KUNIEDA, Tokyo (JP)

(21) Appl. No.: 15/471,299

(22) Filed: Mar. 28, 2017

Related U.S. Application Data
(63) Continuation of application No. PCT/JP2016/002733, filed on Jun. 7, 2016.

(30) Foreign Application Priority Data
Jun. 12, 2015 (JP) 2015-119702

(51) Int. Cl. G06Q 30/06

(52) U.S. Cl. CPC G06Q 30/0607

(57) ABSTRACT

in sale of age-restricted products, a sales support method and sales support system are provided that allow reduction in time and effort for dealing with false statement of age. The sales support method for supporting sale of age-restricted products include acquiring input information indicating whether a customer is at predetermined age and over or under the predetermined age, acquiring age estimation information indicating age of the customer estimated using biometric information obtained by observation of the customer, determining whether the customer is at the predetermined age and over based on the age estimation information when the input information indicates that the customer is at the predetermined age and over, and notifying determination results.

### BACKGROUND

1. Technical Field

The present disclosure relates to a sales support method and a sales support system for supporting sale of age-restricted products.

2. Description of the Related Art

In sale of age-restricted products such as alcoholic beverages and cigarettes, it is necessary to verify age of a customer who intends to purchase the products and to sell the products after obtaining verification that age restrictions are met. Conventionally, various techniques have been proposed as an apparatus to support sale of such an age-restricted product.

In PTL 1, a customer who purchases an age-restricted product is requested to report his or her age, and when the reported age exceeds restricted age, age verification is performed with an age certificate, such as a driver's license and health insurance card. Accurate age verification performed by such a method prevents unjust age reporting and facilitates age verification of the customer who intends to purchase the age-restricted product.

### CITATION LIST

### Patent Literature

PTL 1: Unexamined Japanese Patent Publication No. 2014-2686

### SUMMARY

The present disclosure provides a sales support method and sales support system capable of reducing time and effort for dealing with false statement of age in sale of age-restricted products.

A sales support method according to the present disclosure is a sales support method for supporting sale of an age-restricted product. The sales support method includes: acquiring input information indicating whether a customer is at predetermined age and over or under the predetermined age; acquiring age estimation information indicating age of the customer estimated using biometric information obtained by observation of the customer; when the input information indicates that the customer is at the predetermined age and over, determining whether the customer is at the predetermined age and over based on the age estimation information; and notifying a determination result.

A sales support system according to the present disclosure is a sales support system for supporting sale of an age-restricted product. The sales support system includes: an input device for inputting information indicating whether a customer is at predetermined age and over or under the predetermined age; an age estimation apparatus that estimates age of the customer by using biometric information obtained by observation of the customer; a determination unit that determines whether the customer is at the predetermined age and over based on age estimation information when the input information indicates that the customer is at the predetermined age and over; and a notification unit that notifies a determination result made by the determination unit.

The sales support method and sales support system according to the present disclosure allow reduction in time and effort for dealing with false statement of age in sale of age-restricted products.

### BRIEF DESCRIPTION OF THE DRAWINGS

FIG. 1 is a diagram illustrating one example of layout of a store in which a sales support system is installed according to the exemplary embodiment;

FIG. 2 is a diagram illustrating a sales support terminal installed in each of aisles illustrated in FIG. 1;

FIG. 3 is a block diagram illustrating detailed configurations of a store server illustrated in FIG. 1 and the sales support terminal illustrated in FIG. 2;

FIG. 4 is a flowchart illustrating an operation of the sales support system according to the exemplary embodiment;

FIG. 5A is a communication sequence diagram illustrating one example of the operation of the sales support system according to the exemplary embodiment;

FIG. 5B is a communication sequence diagram illustrating another example of the operation of the sales support system according to the exemplary embodiment;

FIG. 5C is a communication sequence diagram illustrating still another example of the operation of the sales support system according to the exemplary embodiment;

FIG. 5D is a communication sequence diagram illustrating still another example of the operation of the sales support system according to the exemplary embodiment;

FIG. 6 is a diagram illustrating a display example of images for age verification to be made by an input device;

FIG. 7 is a diagram illustrating a display example of a determination result to be made by a determination unit in a display of a POS register;

FIG. 8 is a diagram illustrating a specific example of the operation of the sales support system according to the exemplary embodiment;

FIG. 9 is a block diagram illustrating a detailed configuration of the sales support system according to another exemplary embodiment; and

FIG. 10 is a communication sequence diagram illustrating one example of the operation of the sales support system according to another exemplary embodiment.

### DETAILED DESCRIPTION

Exemplary embodiments will be described in detail below with reference to the drawings as needed. However, a description more detailed than necessary may be omitted. For example, a detailed description of an already well-known matter and a repeated description of substantially identical components may be omitted. This is intended to avoid the following description from becoming unnecessarily redundant and to make the description easier for a person skilled in the art to understand.

It is to be noted that the inventors provide the accompanying drawings and the following description in order for a person skilled in the art to fully understand the present disclosure, and that the inventors do not intend to limit the subject described in the appended claims. That is, all of the exemplary embodiments to be described below illustrate one specific example of the present disclosure. Numerical values, shapes, materials, components, disposition positions and connection forms of the components, steps, order of the steps, and the like that are indicated in the following exemplary embodiments are one example, and do not intend to limit the present disclosure. Also, among the components described in the following exemplary embodiments, components that are not described in an independent claim which represents the highest concept are described as optional components.

### Exemplary Embodiment

An exemplary embodiment will be described with reference to the drawings.

### [1. Configuration]

FIG. 1 is a diagram illustrating one example of layout of store 30 in which a sales support system is installed according to the exemplary embodiment. Store 30 is provided with product shelves 36a to 36c that display various products including age-restricted products, aisles 34a to 34c for paying purchased products, sales support terminals (not illustrated) installed in respective aisles 34a to 34c, and store server 10 that is connected to communication network 32 and installed in a backyard. Store server 10 is one example of a sales support apparatus that supports sale of age-restricted products and that is provided in each store, and for example, store server 10 is a computer apparatus. Store server 10 may also function as a server of a point of sales (POS) system, and may be connected to an external computer apparatus, such as a cloud server, via a communication network such as the Internet.

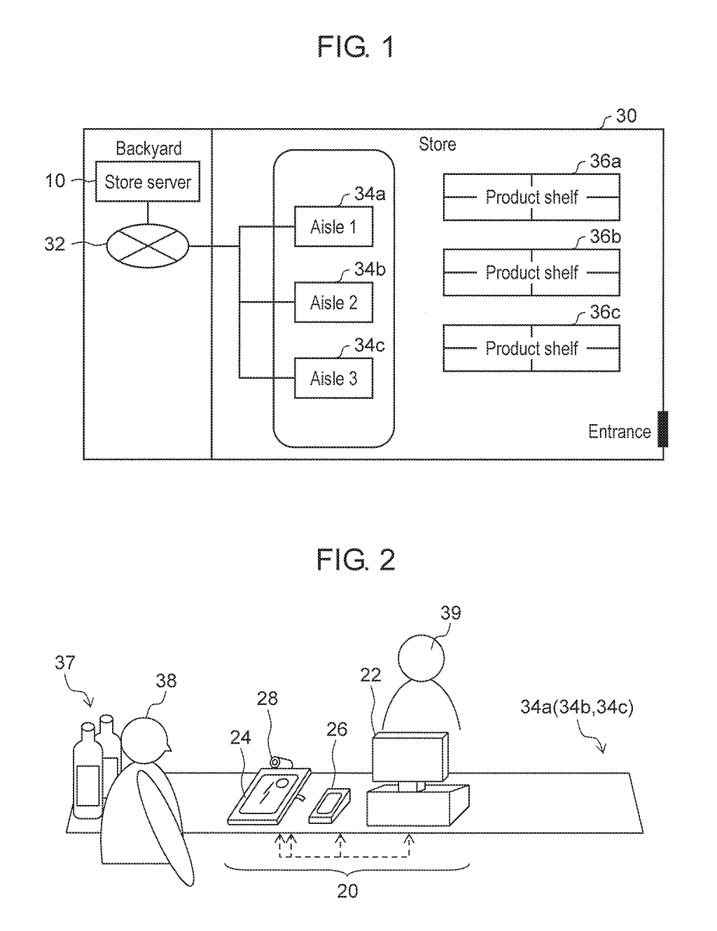

FIG. 2 is a diagram illustrating sales support terminal 20 installed in each of aisles 34a to 34c (here, aisle 34a) illustrated in FIG. 1. FIG. 2 illustrates how customer 38 who purchases age-restricted product 37, such as alcoholic beverages, pays in aisle 34a of which salesclerk 39 takes charge. Sales support terminal 20 is one example of the sales support terminal that supports sale of age-restricted products. Sales support terminal 20 includes POS register 22, input device 24, ID scanner 26, and camera 28.

POS register 22 is a cash register having a terminal function of a POS system. Input device 24 is one example of an input device for age verification to input information about whether customer 38 is at predetermined age and over or under the predetermined age. Input device 24 is, for example, a tablet terminal. ID scanner 26 is a device that reads information from an ID card in which information for acquiring age of the customer is recorded. ID scanner 26 is, for example, a bar code reader, magnetic card reader, or IC card reader. Camera 28, such as a digital camera, is one example of an age estimation apparatus that estimates the age of the customer by using biometric information (face in the present exemplary embodiment) obtained by observation of the customer. According to the present exemplary embodiment, input device 24 and camera 28 are integrated as a tablet terminal. Camera 28 is incorporated in an upper part of input device 24.

Camera 28 is incorporated in the upper part of input device 24 in order to use facial images during age estimation performed by camera 28. When customer 38 inputs with input device 24 information regarding whether customer 38 is at predetermined age and over or under the predetermined age, sales support terminal 20 uses a position of a face of customer 38 in the upper part of input device 24. In performing age estimation, when brightness of the surroundings is insufficient, brightness in the surroundings may be secured by increasing light quantity of a back light of input device 24 (for example, tablet).

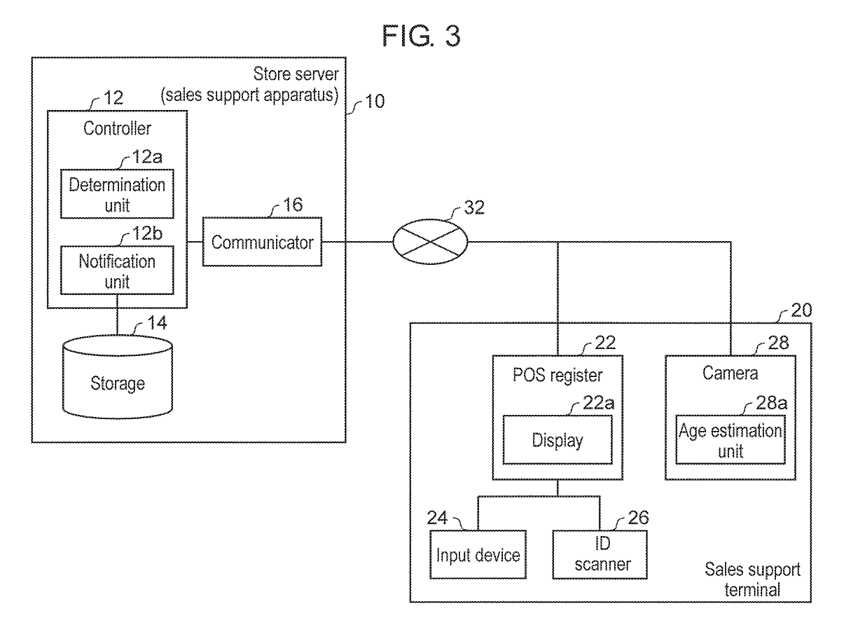

FIG. 3 is a block diagram illustrating detailed configurations of store server 10 illustrated in FIG. 1 and sales support terminal 20 illustrated in FIG. 2. Store server 10, which is one example of the sales support apparatus, and sales support terminal 20 constitute the sales support system that supports sale of age-restricted products.

Sales support terminal 20 includes POS register 22, input device 24, ID scanner 26, and camera 28. Here, input device 24 and ID scanner 26 are connected to POS register 22. POS register 22 and camera 28 are connected to store server 10 via communication network 32.

POS register 22 reads bar code information applied to a product with a scanner (not illustrated), and includes display 22a that displays the read bar code information and the like.

Camera 28 is an image pickup device, and includes age estimation unit 28a that estimates the age of the customer by using an image obtained by capturing the customer (that is, facial image) and transmits age estimation information that indicates the estimated age to store server 10. Age estimation unit 28a is implemented, for example, by components such as a memory that stores a control program and a processor that executes the control program. A process for estimating the age of the customer from the facial image of the customer employs, for example, a method for learning correspondence between a feature amount extracted from a facial image with age information proved in advance and age of the face, and for estimating the age from the feature amount extracted from a facial image with unknown age based on a result of the learning (for example, refer to PTL 2 (Japanese Patent No. 5072102)). Also, “age” of the customer to estimate is not limited to one numerical value, but may be a numerical value range (age bracket), such as from age 15 to age 18, or at age 30 and over.

When there is a request from store server 10, camera 28 sends, to store server 10, age estimation information of a person who is being captured by camera 28 at that time, that is, the customer who is undergoing age verification performed by input device 24. While the age estimation information may be the age estimated at that time by using only an image of predetermined timing, according to the present exemplary embodiment, camera 28 transmits, as the age estimation information, an average of a plurality of ages estimated during a period from timing when camera 28 detects the face of the customer until timing of age verification when input device 24 receives the information indicating whether the customer is at predetermined age and over or under the predetermined age.

According to the present exemplary embodiment, input device 24 includes a touch-panel display (not illustrated), and converses with customer 38 by a graphical user interface (GUI) via the touch-panel display under control of store server 10 and POS register 22. Specifically, when a product that customer 38 intends to purchase is found to be an age-restricted product by POS register 22 (reading of the bar code information applied to the product), for purposes of age verification, input device 24 acquires input information from customer 38 through dialog with customer 38, the input information indicating one of whether customer 38 is at predetermined age and over, whether customer 38 is under the predetermined age, and whether customer 38 refuses to input information regarding whether customer 38 is at the predetermined age and over or under the predetermined age (whether customer 38 refuses to reply). Input device 24 then transmits the acquired input information to store server 10. Here, the age-restricted product refers to a product of which sale to customers under predetermined age is restricted. The predetermined age is determined depending on country, area, or any other conditions. For example, in Japan, the age-restricted product includes alcoholic beverages and cigarettes of which sale is restricted to persons under age 20.

ID scanner 26 reads information for acquiring the age of customer 38 from the ID card that customer 38 possesses, identifies the age of customer 38 from the read information, and transmits age information that indicates the identified age to store server 10. When the age information is recorded in the ID card that customer 38 possesses, ID scanner 26 transmits the read age information as it is to store server 10. When the age information is not recorded in the ID card that customer 38 possesses, ID scanner 26 acquires the age information registered in store server 10 or other database from an ID recorded in the ID card (for example, a member ID), and then ID scanner 26 transmits the acquired age information to store server 10.

Store server 10 is one example of the sales support apparatus that supports sale of age-restricted products. Store server 10 includes controller 12, storage 14, and communicator 16.

Communicator 16 is a communication adapter that communicates with sales support terminal 20 via communication network 32. According to the present exemplary embodiment, under control of controller 12, communicator 16 acquires the input information from input device 24, acquires the age estimation information from camera 28, or acquires the age information from ID scanner 26.

Storage 14 is an apparatus for storing a process result performed by controller 12 and other information. For example, storage 14 is a nonvolatile memory such as a hard disk.

Controller 12 is a controller that controls sales support terminal 20 via communicator 16. Controller 12 includes determination unit 12a and notification unit 12b as functional processors. These processors are implemented by components such as a memory in which a control program is stored and a processor that executes the control program. The control program is included in controller 12.

When the input information acquired from input device 24 via communicator 16 indicates that customer 38 is at predetermined age and over, determination unit 12a determines whether customer 38 is at the predetermined age and aver based on the age estimation information acquired from camera 28 via communicator 16. When this results in determination that customer 38 is not at the predetermined age and over, determination unit 12a determines whether customer 38 is at the predetermined age and over based on the ID card in which information for acquiring the age of the customer is recorded. For example, determination unit 12a determines whether customer 38 is at the predetermined age and over by controlling sales support terminal 20 and reading the age information from the ID card that customer 38 possesses via ID scanner 26. Also, when the input information acquired from input device 24 via communicator 16 indicates that the customer refuses to input information regarding whether customer 38 is at predetermined age and over or under the predetermined age, determination unit 12a determines whether customer 38 is at the predetermined age and over based on the ID card in which information for acquiring the age of the customer is recorded. When the input information acquired from input device 24 via communicator 16 indicates that customer 38 is under predetermined age, determination unit 12a does not acquire and use the age estimation information from camera 28 via communicator 16.

Notification unit 12b notifies sales support terminal 20 of determination results made by determination unit 12a. Specifically, when the input information acquired from input device 24 indicates that customer 38 is at predetermined age and over, and when determination unit 12a determines whether customer 38 is at the predetermined age and over based on the age estimation information acquired from camera 28, then notification unit 12b transmits the determination result to sales support terminal 20 and displays the determination result on display 22a of POS register 22. Also, when determination unit 12a determines whether customer 38 is at predetermined age and over based on the ID card, notification unit 12b transmits the determination result to sales support terminal 20 and displays the determination result on display 22a of POS register 22.

### [2. Operation]

Next, operations of the sales support system (store server 10 and sales support terminal 20) configured as described above according to the present exemplary embodiment will be described.

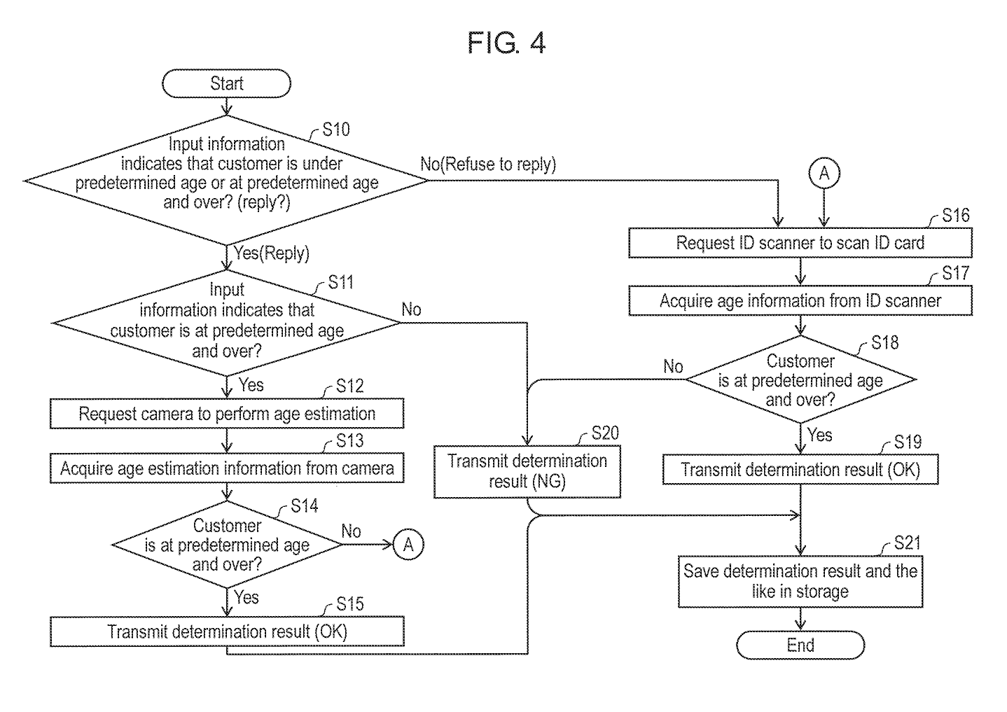

FIG. 4 is a flowchart illustrating the operation (that is, sales support method) of the sales support system (store server 10) according to the exemplary embodiment. FIG. 4 illustrates a flow that mainly describes the process in store server 10 when the product that customer 38 intends to purchase is found out to be the age-restricted product (the product of which sale to customers under predetermined age is restricted) by PUS register 22 (that is, reading of the bar code information applied to the product). Here, it is assumed that input device 24 provides input information indicating that customer 38 is under predetermined age or at the predetermined age and over, or the input information indicating that the customer 38 refuses to reply (input) to a question whether customer is at the predetermined age and over or under the predetermined age, and that the input information is transmitted from input device 24 to store server 10.

First, determination unit 12a determines whether the input information acquired from input device 24 via communicator 16 indicates that customer 38 is at the predetermined age and over or under the predetermined age, that is, whether customer 38 replies (inputs) or refuses to a question whether the customer is at the predetermined age and over or under the predetermined age (S10).

As a result, when the input information indicates that customer 38 is at the predetermined age and over or under the predetermined age, that is, when customer 38 replies (inputs) to the question whether the customer is at the predetermined age and over or under the predetermined age (Yes in S10), next, determination unit 12a determines whether the input information indicates that customer 38 is at the predetermined age and over or customer 38 is under the predetermined age (S11).

As a result, when the input information indicates that customer 38 is at the predetermined age and over (Yes in S11), determination unit 12a requests camera 28 installed in the aisle from which the input information has been sent to perform age estimation via communicator 16 (S12). Accordingly, age estimation unit 28a of camera 28 captures an image of customer 38, estimates the age of the customer by using the obtained image (that is, facial image), and transmits the age estimation information indicating the estimated age to store server 10.

Then, determination unit 12a acquires the age estimation information on customer 38 from camera 28 via communicator 16 (information acquisition step S13), and based on the acquired age estimation information, determination unit 12a determines whether customer 38 is at the predetermined age and over or not (S14). For example, when the predetermined age is age 20 and the age estimation information indicates a range from age 15 to age 18, determination unit 12a determines that customer 38 is not at the predetermined age and over. When the age estimation information indicates age 30 and over, determination unit 12a determines that customer 38 is at the predetermined age and over. In a case where the acquired age estimation information indicates age that does not allow determination whether customer 38 is at the predetermined age and over or under the predetermined age (for example, an age bracket from under the predetermined age to the predetermined age and over), or in a case where the acquired age estimation information indicates that the age estimation fails for a reason that the face is not recognized or other reasons, determination unit 12a determines that customer 38 is not at the predetermined age and over.

As a result, when determination unit 12a determines that customer 38 is at the predetermined age arid over (YES in S14), notification unit 12b transmits a determination result (for example, information indicating “OK”) to POS register 22 of sales support terminal 20 via communicator 16 (notification step S15). Accordingly, the determination result (for example, “OK”) is displayed on display 22a of POS register 22.

Meanwhile, in step S10, when the input information does not indicate that customer 38 is under the predetermined age or at the predetermined age and over, that is, when customer 38 refuses to reply (input) to the question whether the customer is at the predetermined age and over or under the predetermined age (No in S10), and when determination unit 12a does not determine in step S14 that customer 38 is at the predetermined age and over (No in S14), determination unit 12a requests POS register 22 installed in the aisle from which the input information has been sent to scan the ID card that customer 38 possesses with ID scanner 26 via communicator 16 (S16). Accordingly, this request is displayed on display 22a of POS register 22, salesclerk 39 who sees this display requests customer 38 to present his or her ID card, and customer 38 holds the ID card that customer 38 possesses over ID scanner 26. Then, ID scanner 26 reads the information for acquiring the age of customer 38 from the ID card that customer 38 possesses, identifies the age of customer 38 from the read information, and transmits the age information indicating the identified age to store server 10.

Determination unit 12a of store server 10 acquires the age information transmitted from ID scanner 26 (S17). Determination unit 12a determines whether the acquired age information indicates the predetermined age and over (S18). As a result, when the acquired age information indicates the predetermined age and over (Yes in S18), notification unit 12b transmits the determination result (for example, information indicating “OK”) to POS register 22 of sales support terminal 20 via communicator 16 (notification step S19). Accordingly, the determination result (for example, “OK”) is displayed on display 22a of POS register 22.

Meanwhile, when the age information does not indicate the predetermined age and over in step S18 (No in S18), and when the input information does not indicate that customer 38 is at the predetermined age arid over in step S11 (No in S11), notification unit 12b transmits the determination result (for example, information indicating “not good (NG)”) to POS register 22 of sales support terminal 20 via communicator 16 (notification step S20). Accordingly, the determination result (for example, “NG”) is displayed on display 22a of POS register 22.

After the notification made by notification unit 12b (S15, S19, S20), determination unit 12a identifies current time by referring to a timer (not illustrated) stored in controller 12, and saves the determination result along with the identified current time in storage 14 (S21).

Thus, in the sales support system (store server 10 and sales support terminal 20) according to the present exemplary embodiment, in sale of age-restricted products, when the customer replies that the customer is at predetermined age and over in response to age verification, it is automatically determined whether the customer is at the predetermined age and over based on the age estimation information indicating the age of the customer estimated using biometric information obtained by observation of the customer. That is, when the determination result is “OK” as in step S15, the user is not given awareness of operations other than input operations, and the salesclerk does not need to perform verification operations. Therefore, time and effort for dealing with false statement of age can be reduced.

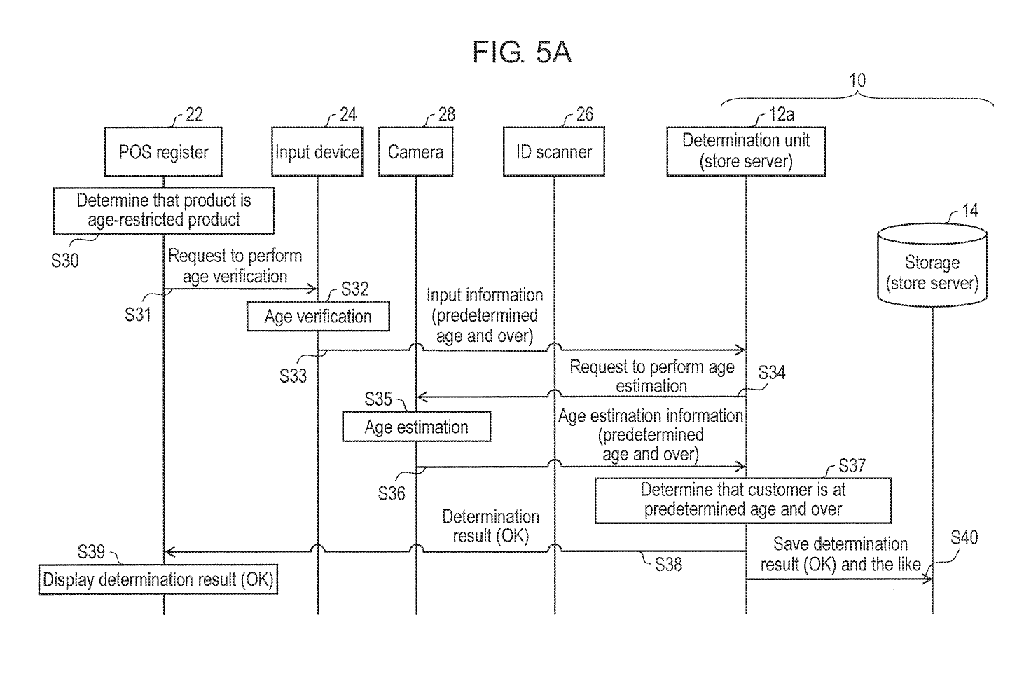

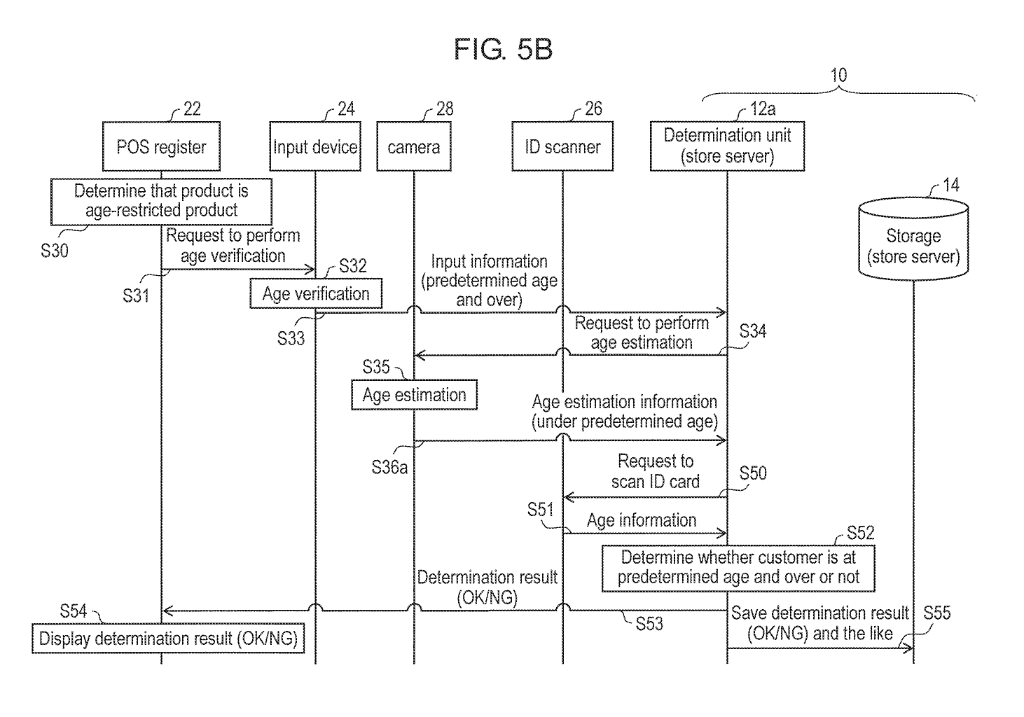

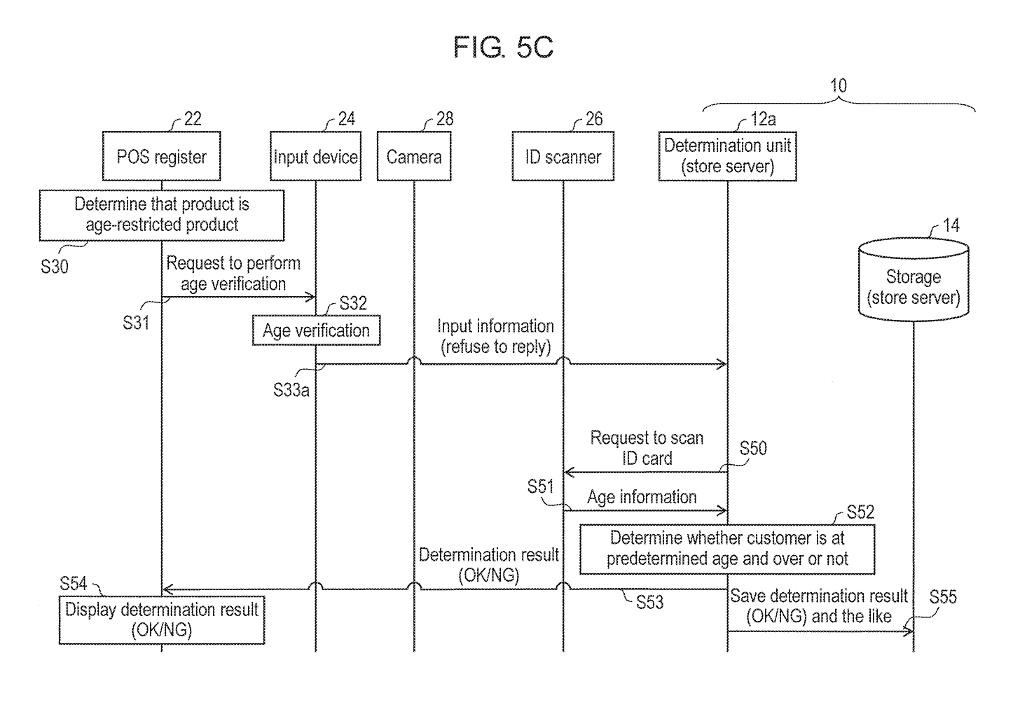

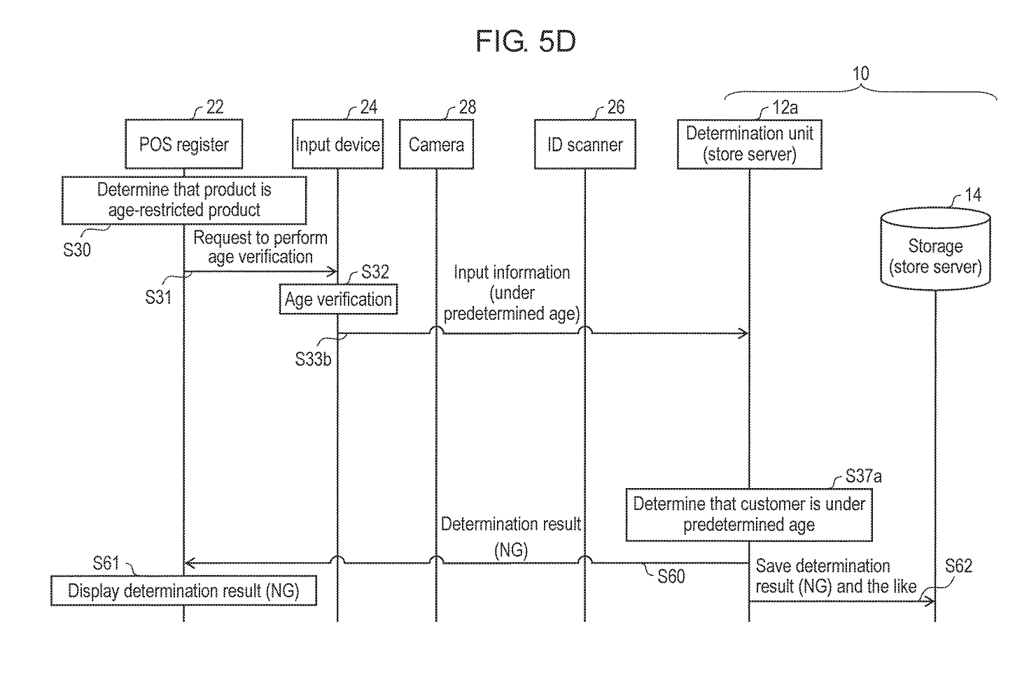

FIG. 5A is a communication sequence diagram illustrating one example of the operation of the sales support system (store server 10 and sales support terminal 20) according to the exemplary embodiment. FIG. 5A illustrates processes and exchange of communications in POS register 22, input device 24, camera 28, ID scanner 26, controller 12 of store server 10, and storage 14 of store server 10. FIG. 5A illustrates the communication sequence in a case where customer 38 replies that customer 38 is at predetermined age and over during age verification and where camera 28 estimates that customer 38 is at the predetermined age and over.

When POS register 22 reads the bar code information applied to the product that customer 38 intends to purchase to determine that the product is an age-restricted product (a product of which sale to customers under predetermined age is restricted) (S30), POS register 22 requests input device 24 to perform age verification (S31).

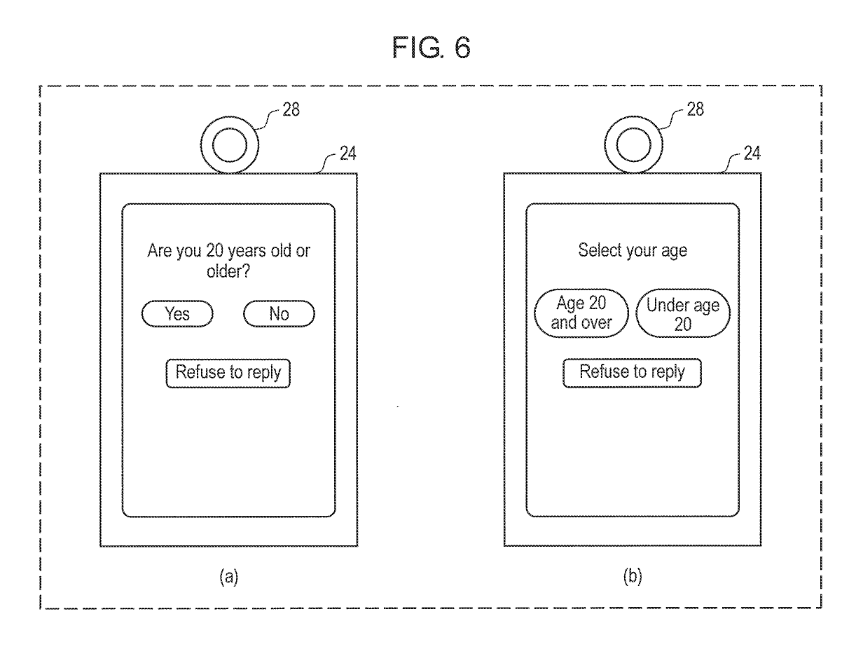

On receipt of the age verification request, input device 24 acquires a reply to the age verification request from customer 38 (here, a reply that customer 38 is at predetermined age and over) by displaying an image illustrated in FIG. 6(a) or FIG. 6(b) (S32). Input device 24 then transmits the input information that indicates the acquired reply (here, input information indicating that customer 38 is at the predetermined age and over) to store server 10 along with an aisle ID (S33). The aisle ID is an identifier of the aisle in which input device 24 is installed. The aisle ID is stored in advance in POS register 22, and is referred to by input device 24 or stored in input device 24.

In store server 10 that acquires from input device 24 the input information indicating that customer 38 is at the predetermined age and over, determination unit 12a requests camera 28 installed in the aisle from which the input information has been sent to perform the age estimation (S34).

In camera 28 that receives the age estimation request, age estimation unit 28a captures an image of customer 38, estimates the age of customer 38 by using the obtained image (that is, facial image) (S35), and transmits the age estimation information indicating the estimated age to store server 10 (S36). In a case illustrated in FIG. 5A, it is assumed that the age estimation information indicates predetermined age and over.

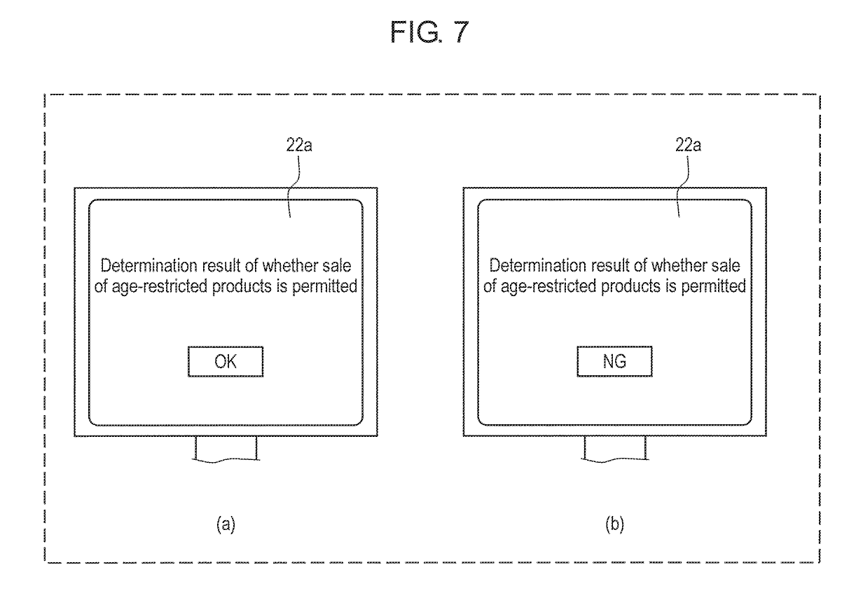

In store server 10 that acquires the age estimation information indicating the estimated age at the predetermined age and over, determination unit 12a determines that customer 38 is at the predetermined age and over based on the acquired age estimation information (S37). Then, notification unit 12b transmits the determination result made by determination unit 12a (here, information that indicates “OK”) to POS register 22 (S38). On receipt of the determination result that indicates “OK”, POS register 22 displays the determination result (here, “OK”) on display 22a as in the display example illustrated in FIG. 7(a) (S39).

Subsequently, determination unit 12a identifies current time by referring to the timer (not illustrated) stored in controller 12, and saves the determination result and other information (such as the aisle ID, current time, input information, age estimation information, determination result) along with the identified current time in storage 14 (S40).

Thus, in the sales support system according to the present exemplary embodiment, when customer 38 replies that customer 38 is at the predetermined age and over during the age verification, determination is made whether camera 28 estimates that customer 38 is at the predetermined age and over. When estimation is made that customer 38 is at the predetermined age and over, sale of age-restricted products is permitted without requesting presentation of the ID card. This allows reduction of time and effort for dealing with false statement of age.

FIG. 5B is a communication sequence diagram illustrating one example of the operation of the sales support system (store server 10 and sales support terminal 20) according to the exemplary embodiment. FIG. 5B illustrates the communication sequence in a case where customer 38 replies that customer 38 is at predetermined age and over during age verification, and where camera 28 estimates that customer 38 is under the predetermined age.

Since steps S30 to S35 are identical to the process steps illustrated in FIG. 5A, identical numerical references are assigned and description thereof is omitted.

In the case illustrated in FIG. 5B, in camera 28 that receives the age estimation request from store server 10, age estimation unit 28a captures an image of customer 38, and estimates the age of customer 38 by using the obtained image (that is, facial image) (S35). As a result of the age estimation, age estimation unit 28a estimates age under the predetermined age as the age of customer 38, and transmits the age estimation information that indicates the estimated age of under the predetermined, age to store server 10 (S36a).

In store server 10 that acquires the age estimation information, since the acquired age estimation information indicates the age under the predetermined age, determination unit 12a requests POS register 22 installed in the aisle from which the input information has been sent to scan the ID card that customer 38 possesses with ID scanner 26 (S50). As a result, the salesclerk is notified that scanning with ID scanner 26 is needed. The salesclerk may be notified by using ID scanner 26, or the salesclerk may be notified through display of this notification on display 22a of POS register 22. Accordingly, salesclerk 39 who receives the notification requests customer 38 to present the ID card, and customer 38 holds the ID card that customer 38 possesses over ID scanner 26. Then, ID scanner 26 reads the information for acquiring the age of customer 38 from the ID card that customer 38 possesses, identifies the age of customer 38 from the read information, and transmits the age information that indicates the identified age to store server 10 (S51).

Determination unit 12a of store server 10 determines whether the age information transmitted from ID scanner 26 indicates age at the predetermined age and over or not (S52). Then, notification unit 12b transmits the determination result made by determination unit 12a (information indicating “OK” or “NG”) to POS register 22 (S53). On receipt of the determination result that indicates “OK” or “NG”, POS register 22 displays the determination result (“OK” or “NG”) on display 22a as in the display example illustrated in FIG. 7(a) or FIG. 7(b) (S54). Here, in FIG. 7(b), display may be made indicating that the read product will be canceled simultaneously with display of “NG.”

Subsequently, determination unit 12a identifies current time by referring to the timer (not illustrated) stored in controller 12, and saves the determination result and the like (such as the aisle ID, current time, input information, age estimation information, age information, determination result) along with the identified current time in storage 14 (S55).

Thus, when customer 38 replies that customer 38 is at the predetermined age and over during the age verification, determination is made whether camera 28 estimates that customer 38 is at the predetermined age and over. When estimation is not made that customer 38 is at the predetermined age and over, the customer is requested to present the ID card, and determination is made about whether to permit sale by using the age of the customer identified with the ID card. Therefore, presentation of the ID card is requested only when it is unclear whether the customer satisfies age restriction, and time and effort to always present the ID card when purchasing age-restricted products is avoided.

FIG. 5C is a communication sequence diagram illustrating one example of the operation of the sales support system (store server 10 and sales support terminal 20) according to the exemplary embodiment. FIG. 5C illustrates the communication sequence when customer 38 refuses to reply (input) during age verification.

Since steps S30 to S32 are identical to the process steps illustrated in FIG. 5A and steps S50 to S55 are identical to the process steps illustrated in FIG. 5B, identical numerical references are assigned and description thereof is omitted.

In the case illustrated in FIG. 5C, on receipt of a request to perform age verification from POS register 22, input device 24 acquires a reply (here, an instruction to refuse to reply (input)) to the age verification request from customer 38 by displaying the image illustrated in FIG. 6(a) or FIG. 6(b) (S32). Input device 24 then transmits the input information indicating the acquired instruction (here, input information indicating that the age verification is refused) along with the aisle ID to store server 10 (S33a).

On acquisition of the input information indicating that the age verification is refused, determination unit 12a requests POS register 22 installed in the aisle from which the input information has been sent to scan the ID card that customer 38 possesses with ID scanner 26 to acquire the age information from ID scanner 26. Hereinafter, determination unit 12a performs the processes similar to the processes in the case illustrated in FIG. 5B (S50 to S55).

Thus, when customer 38 refuses to reply during the age verification, the age estimation information from camera 28 is not used, and determination about whether to permit sale is made depending on the age of the customer identified from the ID card. Therefore, presentation of the ID card is requested only when it is unclear whether the customer satisfies the age restriction, and time and effort to always present the ID card when purchasing age-restricted products is avoided. It is to be noted that during the age verification, store server 10 may operate so as to determine that the operation to scan the ID card is reply refusal, and the salesclerk may be able to input the reply refusal for a case where the customer refuses to reply orally.

FIG. 5D is a communication sequence diagram illustrating one example of the operation of the sales support system (store server 10 and sales terminal 20) according to the exemplary embodiment. FIG. 5D illustrates the communication sequence when customer 38 replies that customer 38 is under predetermined age during the age verification.

Since steps S30 to S32 are identical to the process steps illustrated in FIG. 5A, identical numerical references are assigned and description thereof is omitted.

In the case illustrated in FIG. 5D, on receipt of a request to perform age verification from POS register 22, input device 24 acquires a reply to the age verification request from customer 38 (here, a reply that customer 38 is under predetermined age) by displaying the image illustrated in FIG. 6(a) or FIG. 6(b) (S32). Input device 24 then transmits the input information indicating the acquired reply (here, input information indicating that customer 38 is under the predetermined age) along with the aisle ID to store server 10 (S33b).

On acquisition of the input information indicating age under the predetermined age, determination unit 12a determines that customer 38 is under the predetermined age (S37a). Notification unit 12b transmits the determination result made by determination unit 12a (here, information indicating “NG”) to POS register 22 (S60). On receipt of the determination result that indicates “NG”, POS register 22 displays the determination result (here, “NG”) on display 22a as in the display example illustrated in FIG. 7(b) (S61).

Subsequently, determination unit 12a identifies current time by referring to the timer (not illustrated) stored in controller 12, and saves the determination result and other information (such as the aisle ID, current time, input information, determination result) along with the identified current time in storage 14 (S62).

Thus, when customer 38 replies during the age verification that customer 38 is under the predetermined age, camera 28 does not perform the age estimation, “NG” indicating prohibition of sale is displayed on display 22a of POS register 22, and inappropriate sale of age-restricted products is avoided.

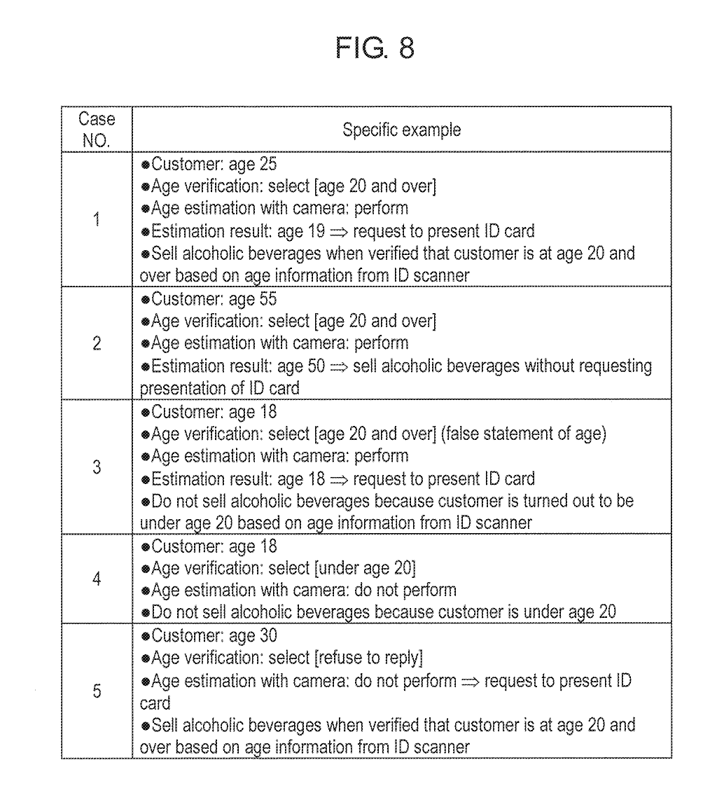

FIG. 8 is a diagram illustrating a specific example of the operation of the sales support system (store server 10 and sales support terminal 20) according to the exemplary embodiment. FIG. 8 illustrates the operation example of the sales support system in five possible cases in which the age-restricted product is alcoholic beverages and the predetermined age is age 20.

Case No.1 is a case where a 25-year-old customer replies as “age 20 and over” in response to the age verification made by input device 24 (refer to FIG. 5B). In this case, camera 28 performs the age estimation. It is assumed that a result of the age estimation is age 19.

In this case, the customer is requested to present the ID card, ID scanner 26 reads information from the ID card and identifies the age, and it becomes clear that the customer is at age 20 and over from the identified age. Therefore, alcoholic beverages are sold.

Case No.2 is a case where a 55-year-old customer replies as “age 20 and over” in response to the age verification made by input device 24 (refer to FIG. 5A). In this case, camera 28 performs the age estimation. It is assumed that the result of the age estimation is age 50.

In this case, alcoholic beverages are sold without requesting the customer to present the ID card.

Case No.3 is a case where a 18-year-old customer replies as “age 20 and over” (false statement of age) in response to the age verification made by input device 24 (refer to FIG. 5B). In this case, camera 28 performs the age estimation. It is assumed that the result of the age estimation is age 18.

In this case, the customer is requested to present the ID card, ID scanner 26 reads the information from the ID card and identifies the age, and it becomes clear that the customer is under age 20 from the identified age. Therefore, alcoholic beverages are not sold.

Case No.4 is a case where an 18-year-old customer replies as “under age 20” in response to the age verification made by input device 24 (refer to FIG. 5D). In this case, camera 28 does not perform the age estimation.

In this case, since the customer reports to be under age 20, alcoholic beverages are not sold.

Case No.5 is a case where a 30-year-old customer refuses to reply (input) in response to the age verification made by input device 24 (refer to FIG. 5C). In this case, camera 28 does not perform the age estimation.

In this case, the customer requested to present the ID card, and ID scanner 26 reads information from the ID card and identifies the age. When it is verified that the customer is at age 20 and over from the identified age, alcoholic beverages are sold.

### [3. Advantageous Effects and the Like]

As described above, store server 10 according to the present exemplary embodiment is a sales support apparatus for supporting sale of age-restricted products. Store server 10 is connected to input device 24 for inputting information whether the customer is at predetermined age and over or under the predetermined age, and to camera 28 as the age estimation apparatus that estimates the age of the customer by using the biometric information obtained by observation of the customer. As characteristic components, store server 10 includes: communicator 16 that acquires the input information that is input into input device 24 and the age estimation information that indicates the age estimated by the age estimation apparatus; determination unit 12a that determines whether the customer is at the predetermined age and over based on the age estimation information acquired by communicator 16 when the input information acquired by communicator 16 indicates that the customer is at the predetermined age and over; and notification unit 12b that notifies the determination result made by determination unit 12a.

Accordingly, in sale of age-restricted products, when the customer replies that the customer is at the predetermined age and over in response to the age verification, determination is made whether the customer is at the predetermined age and over based on the age estimation information indicating the age of the customer estimated by using the biometric information obtained by observation of the customer. This allows reduction in time and effort for dealing with false statement of age.

When determination unit 12a determines that the customer is not at the predetermined age and over, determination unit 12a determines whether the customer is at the predetermined age and over based on the ID card in which the information for acquiring the age of the customer is recorded.

Accordingly, the age verification with the ID card is performed only when the age estimated using the biometric information obtained by observation of the customer is not at the predetermined age and over. This allows reduction in time and effort of the age verification compared with a conventional case where presentation of an age certificate is always requested.

Furthermore, input device 24 receives refusal to input the information regarding whether the customer is at the predetermined age and over or under the predetermined age. When the input information indicates that the customer refuses to input the information regarding whether the customer is at the predetermined age and over or under the predetermined age, determination unit 12a determines whether the customer is at the predetermined age and over based on the ID card in which the information for acquiring the age of the customer is recorded.

Accordingly, even if the customer refuses to reply to the question whether the customer is at the predetermined age and over or under the predetermined age, the age verification using the ID card is performed, and thus age-restricted products can be sold after the age verification is performed.

When the input information indicates that the customer is under the predetermined age, determination unit 12a does not use the age estimation information.

Accordingly, when the customer replies to the age verification that the customer is under the predetermined age, the age estimation apparatus avoids performing useless age estimation.

The age estimation apparatus is an image pickup device (camera 28) and estimates the age of the customer by using the image obtained by capturing the customer.

Accordingly, capturing the image with the camera allows easy acquisition of the biometric information of the customer and allows estimation of the age of the customer.

The sales support system according to the present exemplary embodiment is a sales support system for supporting sale of age-restricted products. The sales support system according to the present exemplary embodiment includes input device 24 for inputting information about whether the customer is at predetermined age and over or under the predetermined age, camera 28 as the age estimation apparatus that estimates the age of the customer by using the biometric information obtained by observation of the customer, and store server 10 as the sales support apparatus connected to input device 24 and the age estimation apparatus.

Accordingly, in sale of age-restricted products, when the customer replies that the customer is at the predetermined age and over to the age verification made by input device 24, based on the age estimation information indicating the estimated age of the customer obtained by the age estimation apparatus, store server 10 determines whether the customer is at the predetermined age and over. This allows reduction in time and effort for dealing with false statement of age.

In sales support terminal 20 according to the present exemplary embodiment, input device 24 and camera 28 are integrated. Input device 24 is for inputting the information about whether the customer is at the predetermined age and over or under the predetermined age. Camera 28 functions as the age estimation apparatus that estimates the age of the customer by using the biometric information obtained by observation of the customer.

Accordingly input device 24 and camera 28, which are peripheral devices that constitute sales support terminal 20, are integrated, and the space-saving sales support terminal is implemented.

The sales support method according to the present exemplary embodiment is a sales support method for supporting sale of an age-restricted product. The sales support method includes: an information acquisition step of acquiring input information indicating whether the customer is at predetermined age and over or under the predetermined age, and age estimation information indicating the age of the customer estimated using biometric information obtained by observation of the customer; a determination step of determining whether the customer is at predetermined age and over based on the age estimation information acquired in the information acquisition step when the input information acquired in the information acquisition step indicates that the customer is at the predetermined age and over; and a notification step of notifying a determination result made in the determination step.

Accordingly, in sale of age-restricted products, when the customer replies that the customer is at the predetermined age and over in response to the age verification, determination is made whether the customer is at the predetermined age and over based on the age estimation information indicating the age of the customer estimated using the biometric information obtained by observation of the customer. This allows reduction in time and effort for dealing with false statement of age.

### Other Exemplary Embodiments

While the sales support method and the sales support system have been described above according to the exemplary embodiment, the present invention is not limited to this exemplary embodiment. Other exemplary embodiments to which various modifications conceivable by a person skilled in the art are made and other exemplary embodiments that are made by combining some components of the exemplary embodiment are also within the scope of the present invention as long as such exemplary embodiments do not depart from the gist of the present invention.

For example, while store server 10 installed in store 30 functions as the sales support apparatus according to the above-described exemplary embodiment, a position (apparatus) where the function as the sales support apparatus is to be mounted is not limited to store server 10. The function may be mounted inside sales support terminal 20 (for example, POS register 22), and the function may be mounted inside an external computer apparatus connected to store server 10 such as a cloud server.

While peripheral devices of sales support terminal 20 (input device 24, ID scanner 26, and camera 28) are configured as separate bodies from POS register 22 according to the above-described exemplary embodiment, the peripheral devices may be integrated with POS register 22. This allows implementation of compact sales support terminal 20 and achievement of space-saving.

While input device 24 uses a touch panel according to the above-described exemplary embodiment, input device 24 may be a physical button or other devices.

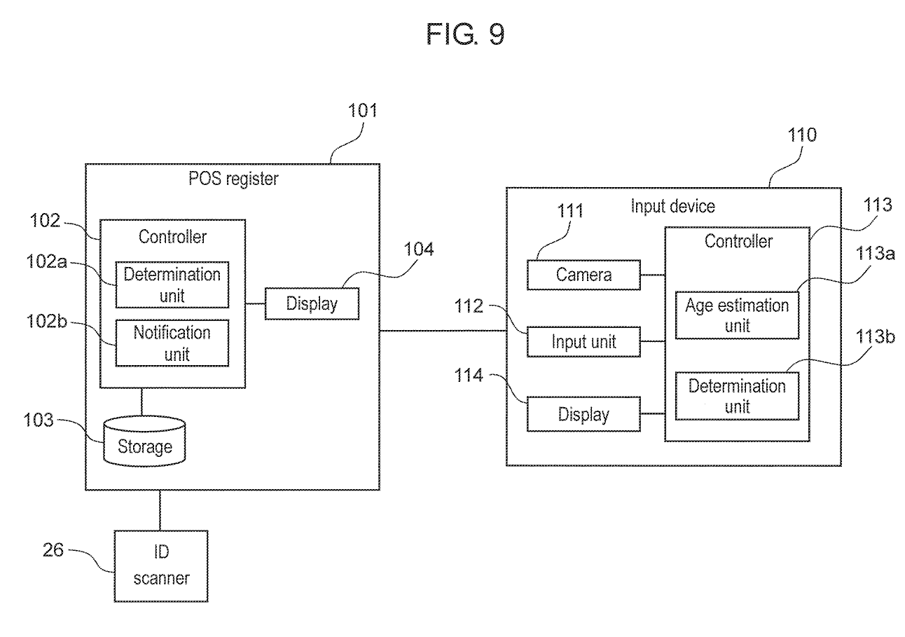

For example, the input device may be configured as illustrated in FIG. 9 as one example. FIG. 9 is a block diagram illustrating a detailed configuration of the sales support system according to another exemplary embodiment. Unlike FIG. 3, in FIG. 9, functions of the store server (sales support apparatus) and the camera are mounted in the POS register and the input device. The sales support system includes POS register 101, input device 110, and ID scanner 26.

PUS register 101 includes controller 102, storage 103, and display 104. Controller 102 includes determination unit 102a that determines whether the customer is at predetermined age and over, and notification unit 102b that notifies a result of the determination. Storage 103 stores the result of controller 102 and other information. Display 104 displays a result of reading bar code information and a result of age determination.

Input device 110 is, for example, a terminal such as a tablet, and includes camera 111, input unit 112, controller 113, and display 114. Controller 113 includes age estimation unit 113a that estimates the age of the customer from an image of camera 111 and determination unit 113b that determines whether the customer is at predetermined age and over based on the result of age estimation unit 113a (age estimation information).

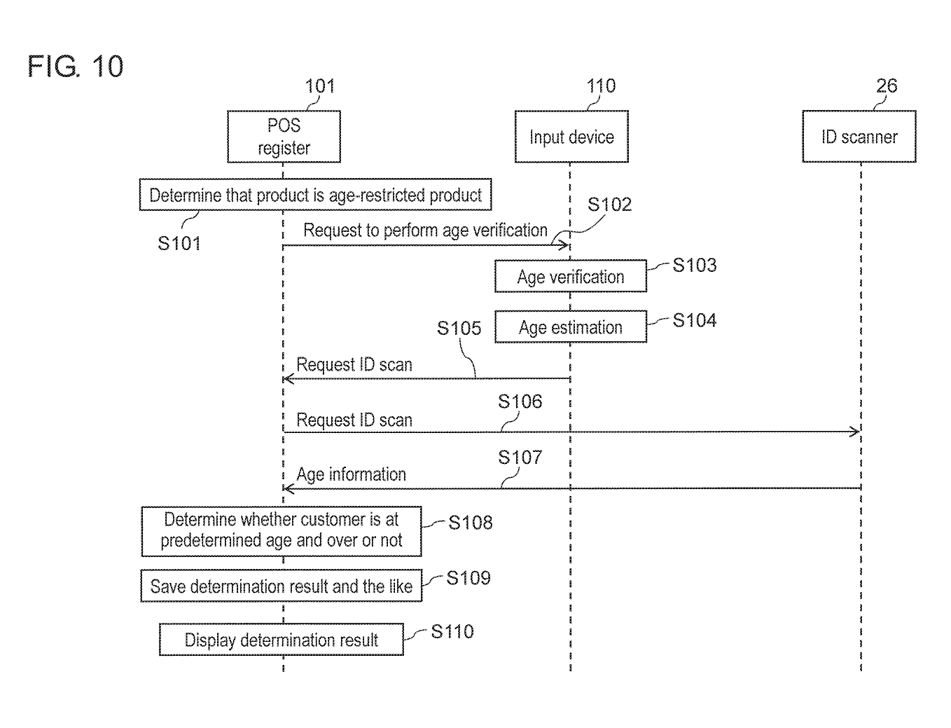

The operation of the sales support system configured as described above will be described with reference to FIG. 10. FIG. 10 is a communication sequence diagram illustrating one example of the operation of the sales support system according to another exemplary embodiment. FIG. 10 describes a case similar to the case of FIG. 5B.

POS register 101 reads bar code information applied to a product that customer 38 intends to purchase, and on determination that the product is an age-restricted product (S101), POS register 101 requests input device 110 to perform age verification (S102).

On, receipt of the age verification request, input device 110 displays an image illustrated in FIG. 6 on display 114, and acquires a reply to the age verification (here, a reply that the customer is at predetermined age and over) from the customer (S103). Then, since the age of the customer is at the predetermined age and over, determination unit 113b of input device 110 instructs age estimation unit 113a of input device 110 to perform age estimation. Age estimation unit 113a estimates the age based on an image of the customer acquired with camera 111 (S104). It is assumed here that the age estimation result is under the predetermined age.

At this time, since the age estimation result differs from the reply of the customer, determination unit 113b of input device 110 requests POS register 101 to perform ID scan (S105).

In response to the request of input device 110, POS register 101 requests ID scanner 26 to perform ID scan (S106), and acquires the age information on the ID card that the customer possesses via ID scanner 26 (S107).

Determination unit 102a of POS register 101 determines whether the customer is at the predetermined age and over based on the age information (S108), saves a result of the determination in storage 103 (S109), and displays the result on display 104 via notification unit 102b (S110).

When the reply of the customer is under the predetermined age, determination unit 113b of input device 110 determines as NG and notifies POS register 101 of the result. Determination unit 102a displays the NG determination of determination unit 113b as it is on display 104 via notification unit 102b.

When the reply of the customer is the predetermined age and over and the determination result made by age estimation unit 113a is also the predetermined age and over, determination unit 113b determines OK, and notifies POS register 101 of the result. Determination unit 102a displays the OK determination of determination unit 113b as it is on display 104 via notification unit 102b.

When the customer refuses to perform the age verification of S103, the age estimation of S104 is not performed, the ID scan of S105 is requested, and the processes similar to the processes of FIG. 10 are performed.

According to the above-described exemplary embodiment, camera 28 is used as the age estimation apparatus that estimates the age of the customer by using the biometric information obtained by observation of the customer; however, the age estimation is not limited to this example, and the age of the customer may be estimated from the biometric information such as bodily characteristics that allows identification of the customer, such as voice and fingerprint. The process for estimating the age of the customer from the biometric information, such as voice and fingerprint of the customer, may use, for example, in a similar manner to the above-described age estimation with the facial image, a method for learning correspondence between the age and a feature amount extracted from the biometric information in which the age is proved in advance, such as voice and fingerprint, and estimating the age from the feature amount extracted from the biometric information in which the age is unknown, such as voice and fingerprint, based on a result of the learning. Furthermore, higher-precision age estimation may be performed by using two or more pieces of biometric information from a plurality of pieces of biometric information such as image, voice, and fingerprint. That is, as an age estimation method, instead of causing a user to be aware of an operation other than an age verification operation, such as causing the user to present the ID card, the age may be estimated without causing the user to be aware of operations other than an input operation, such as age estimation with camera 28.

According to the above-described exemplary embodiment, age estimation unit 28a is provided, inside camera 28; however, age estimation unit 28a may be provided inside POS register 22, store server 10, or the above-described external computer apparatus such as a cloud server. When age estimation unit 28a is provided in store server 10, camera 28 captures the image of the customer and sends the obtained image to store server 10. Age estimation unit 28a provided in store server 10 (or controller 12 or determination unit 12a) estimates the age of the customer by analyzing the acquired image, and generates the age estimation information that indicates the estimated age. Accordingly, a general-purpose digital camera that does not have age estimation unit 28a may be employed as camera 28.

According to the above-described exemplary embodiment, time identified by store server 10 is used as current time to be saved in storage 14. Instead of this time, or in addition to this time, time may be identified at which input device 24 obtains the reply from the customer in response to the age verification, and the identified time may be transmitted to store server 10 along with the input information and saved in storage 14 of store server 10. Similarly, time at which camera 28 captures the customer may be identified, and the identified time may be transmitted to store server 10 along with the age estimation information and saved in storage 14 of store server 10. Time at which ID scanner 26 reads information from the ID card of the customer may be identified, and the identified time may be transmitted to store server 10 along with the age information and saved in storage 14 of store server 10. Accordingly, accurate time is saved at which the input information, the age estimation information, and the age information are acquired.

Based on the determination result and the like saved in store server 10, for example, statistical data may be output, such as data indicating a degree of agreement between the input result of the customer and the age estimation result. The determination results of a plurality of store servers 10 may be compiled by a cloud server outside the store or the like and may be output as statistical data.

According to the above-described exemplary embodiment, POS register 22 displays the result in response to the determination result; however, POS register 22 may display the result in sound, light (lamp), or the like as an output form other than display.

According to the above-described exemplary embodiment, “OK” and “NG” are used as the determination result; however, the determination result may be information necessary for notification, for example, display data itself illustrated in FIG. 7.

According to the above-described exemplary embodiment, the predetermined age is the age determined, for the age-restricted product; however, the predetermined age may be age different from the age determined for the age-restricted product, (for example, setting the predetermined age as age 30 and above for the age-restricted product for age 20 and above).

According to the above-described exemplary embodiment, refusal to age input is accepted; however, age may be always input and refusal may not be accepted.

According to the above-described exemplary embodiment, POS register 22 determines the age-restricted product by reading the bar code; however, another method may be used. For example, a salesclerk may look at a product and input into POS register 22 that the product requires age verification. Display may be made on input device 24 so as to allow the customer to verify the age automatically when a payment process starts, and the display may always be made on input device 24.

According to the above-described exemplary embodiment, the sales support method illustrated in FIG. 4 can be implemented as a program to be executed by a computer included in store server 10. The program can be circulated through recording on a computer-readable recording medium such as a DVD, and can be circulated via a communication network such as the Internet.

As described above, the exemplary embodiments have been described as illustration of the technique in the present disclosure. For this purpose, the accompanying drawings and detailed description have been provided.

Accordingly, the components described in the accompanying drawings and detailed description may include not only components essential for solving problems but also components unessential for solving problems, in order to illustrate the technique. Therefore, it should not be acknowledged immediately that those unessential components be essential because those unessential components are described in the accompanying drawings and detailed description.

Also, since the above-described exemplary embodiments are intended to illustrate the technique in the present disclosure, various changes, replacements, additions, omissions, etc. may be made within the scope of the appended claims or equivalents thereof.

The present disclosure is applicable to the sales support method and sales support system that allow improvement in accuracy of age verification in sale of age-restricted products compared with a conventional method without taking time and effort. Specifically, the present disclosure is applicable to apparatuses such as the POS register, store server, and cloud server which are connected to the tablet terminal and the digital camera.

What is claimed is:

1. A sales support method for supporting sale of an age-restricted product, the sales support method comprising:
acquiring input information indicating whether a customer is at predetermined age and over or under the predetermined age;
acquiring age estimation information indicating age of the customer estimated using biometric information obtained by observation of the customer;
when the input information indicates that the customer is at the predetermined age and over, determining whether the customer is at the predetermined age and over based on the age estimation information; and
notifying a determination result.

2. The sales support method according to claim 1, further comprising, when determination is made that the customer is not at the predetermined age and over, determining whether the customer is at the predetermined age and over based on an ID card in which information for acquiring the age of the customer is recorded.

3. The sales support method according to claim 1, further comprising, when the input information indicates that the customer is under the predetermined age, determining whether the customer at the predetermined age and over based on the input information.

4. The sales support method according to claims 1, wherein the biometric information is an image obtained by capturing the customer.

5. The sales support method according to claim 4, wherein the image is a facial image of the customer.

6. The sales support method according to claims 1, wherein one of the input information and the age estimation information is acquired when a product is the age-restricted product.

7. The sales support method according to claims 1, wherein
the input information includes information indicating whether the customer refuses to input information regarding whether the customer is at the predetermined age and over or under the predetermined age, and
when the input information indicates that the customer refuses, determination is made whether the customer is at the predetermined age and over based on the ID card in which the information for acquiring the age of the customer is recorded.

8. A sales support system for supporting sale of an age-restricted product, the sales support system comprising:
an input device for inputting information indicating whether a customer is at predetermined age and over or under the predetermined age;
an age estimation apparatus that estimates age of the customer by using biometric information obtained by observation of the customer;
a determination unit that determines whether the customer is at the predetermined age and over based on age estimation information when the input information indicates that the customer is at the predetermined age and over; and
a notification unit that notifies a determination result made by the determination unit.

9. The sales support system according to claim 8, wherein on determination that the customer is not at the predetermined age and over, the determination unit determines whether the customer is at the predetermined age and over based on an ID card in which information for acquiring the age of the customer is recorded.

10. The sales support system according to claim 8, wherein when the input information indicates that the customer is under the predetermined age, the determination unit determines whether the customer is at the predetermined age and over based on the input information.

11. The sales support system according to claims 8, wherein the input device and the age estimation apparatus are integrated.
